(19) United States
(12) Patent Application Publication
(10) Pub. No.: US 2025/0227788 A1
(43) Pub. Date: Jul. 10, 2025

(54) IMPROVED EMLSR MODE IN NON-AP MLDS NOT TRIGGERED BY THE AP MLD

(71) Applicant: CANON KABUSHIKI KAISHA, Tokyo (JP)

(72) Inventors: Julien SEVIN, SAINT AUBIN DU CORMIER (FR); Mickaël LORGEOUX, RENNES (FR)

(21) Appl. No.: 18/853,287

(22) PCT Filed: Apr. 3, 2023
(86) PCT No.: PCT/EP2023/058664

§ 371 Date: Oct. 1, 2024

(30) Foreign Application Priority Data
Apr. 6, 2022 (GB) 2205023.1

(51) Int. Cl. H04W 76/15

(52) U.S. Cl. CPC H04W 76/15

(57) ABSTRACT

When an EMLSR-active non-AP MLD receives, over a first one of its EMLSR links, a first initial control frame from the EMLSR capable AP MLD that does not explicitly trigger it, the non-AP MLD remains in the EMLSR listening operation mode, hence requiring an additional initial control frame to be sent to initiate a frame exchange with the AP MLD. Embodiments of the invention save the cost of this additional frame by requiring the non-AP MLD to switch, responsive to the receiving of the first frame, its EMLSR co-affiliated STA corresponding to the first link from the listening operation state to a disabled frame exchange state, and the other EMLSR co-affiliated STA corresponding to another link of its EMLSR links from the listening operation state to an enabled frame exchange state. The other EMLSR co-affiliated STA is ready to directly receive frames from the AP MLD.

### FIELD OF THE INVENTION

The present invention generally relates to wireless communications and more specifically to Multi-Link (ML) communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between STAs.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D1.5 version (March 2022, below “D1.5 standard”) introduces the Multi-Link (ML) Operation (MLO). MLO improves data throughput by allowing communications between STAs over multiple concurrent and non-contiguous communication links.

MLO enables a non-AP (Access Point) MLD (ML Device) to register with an AP MLD, i.e. to discover, authenticate, associate and set up multiple links with the AP MLD. Each link enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP STAs. The affiliated STAs in both AP MLD and non-AP MLD can use 802.11 mechanisms to communicate with affiliated STAs of another MLD over each of the multiple communication links that are set up.

With the introduction of MLO and of spatial multiplexing capabilities of the MLDs, new Operating Modes (OM) referred to as Enhanced Multi-Link Operating Mode (EML OM), have been introduced in the D1.5 standard, namely the EMLSR (Enhanced Multi-Link Single Radio) mode and the EMLMR (Enhanced Multi-Link Multi-Radio) mode.

The non-AP MLDs declare their support of the EML Operating Modes (known as EML Capabilities) to the AP MLD during the association phase. In operation mode, the activation and the deactivation of an EML Operation Mode is initiated by the non-AP MLD which sends a specific EHT action frame referred to as “EML OM Notification”.

The EMLSR mode, once activated, allows a non-AP MLD to simultaneously listen to a set of enabled links (so-called EMLSR links, usually made of two enabled links) to receive an initial control frame (e.g. an MU-RTS trigger frame, a BSRP trigger frame) from the AP MLD to initiate frame exchange and next to perform data frames exchange with the AP MLD over only one link at a time, usually the link over which the initial control frame is received.

In the current version of the standard, the AP MLD has to explicitly trigger, with an initial control frame, each non-AP MLD with which it wishes to initiate a new frame exchange sequence. This induces signaling costs. Furthermore, an AP MLD that is explicitly triggered or addressed by such an initial control frame is blocked in a so-called EMLSR frame exchange mode, even if the AP MLD does not allocate it resources during the frame exchange sequence. This is not satisfactory.

### SUMMARY OF INVENTION

It is a broad objective of the present invention to overcome some of the foregoing concerns. The present invention seeks to achieve this objective by taking into account the constraints in the scheduling and resource allocation of the data transmission in the EMLSR mode.

In this context, embodiments of the invention provide a communication method in a wireless network, comprising, at a non-access point, non-AP, multi-link device, MLD in an active Enhanced Multi-Link Single Radio, EMLSR, mode:

responsive to receiving, over a first link of a set of enabled links in which links the EMLSR mode is applied, a frame from the AP MLD not explicitly triggering the non-AP MLD (but another non-AP MLD), switching a first affiliated STA corresponding to the first link in the non-AP MLD to a disabled frame exchange state and switching a separate and second affiliated STA corresponding to a second link of the set in the non-AP MLD to an enabled frame exchange state.

A frame not explicitly triggering the non-AP MLD may mean a frame that does not provide a resource unit that the non-AP MLD can access. In the context of IEEE Std 802.11ax™-2021, this includes a frame having no User Info field addressed to the non-AP MLD, i.e. a frame in which none of the conditions are met, assuming the non-AP MLD is already registered to the AP MLD:
an AID12 subfield of the User Info field includes an AID of the non-AP MLD,
an AID12 subfield of the User Info field indicates allocation of one or more random access resource units for non-AP MLDs already associated with the AP MLD.

As soon as the EMLSR-active non-AP MLD understands that the AP MLD is going to perform a frame exchange sequence not involving the non-AP MLD over one of its EMLSR links, it directly switches the other of its EMLSR links to a state allowing a frame exchange. The non-AP MLD is therefore ready to directly exchange with the AP MLD over this other link. Depending on the case, it is no longer blocked on the first EMLSR link if previously involved or no additional initial control frame is needed.

Correspondingly, from the AP MLD's perspective, this allows the AP MLD to directly communicate over the second link. In that case, the present invention also regards a communication method in a wireless network, comprising, at an access point, AP, multi-link device, MLD managing non-AP MLDs operating in an active Enhanced Multi-Link Single Radio, EMLSR, mode:

sending, over a first link of a set of enabled links in which links the EMLSR mode is applied by a first non-AP MLD, a frame, not explicitly triggering the first non-AP MLD, to perform a frame exchange sequence with another non-AP MLD. One thus understands that the first link is shared between the two non-AP MLDs, i.e. it belongs to the two sets of enabled links in which the EMLSR mode is respectively applied by the two non-AP MLDs, and

directly performing a frame exchange with the first non-AP MLD over a second link of the set of enabled links, without prior sending, over the second link, an initial control frame scheduling the first non-AP MLD, i.e. a frame to switch an affiliated STA corresponding to the second link in the first non-AP MLD to an enabled frame exchange state.

Optional features of the invention are defined below with reference to a method, while they can be transposed into device features.

It is a first objective to reduce the signaling costs for example when multiple non-AP MLDs operate in EMLSR modes applied to shared/same link or links. In some embodiments, the frame is an initial control frame from the AP MLD that does not schedule the non-AP MLD, and responsive to the receiving, the first affiliated STA is switched from a listening operation state to the disabled frame exchange state and the separate and second affiliated STA is switched from a listening operation state to the enabled frame exchange state.

A non-AP MLD is said to be not scheduled by the frame if none of its User Info field contains an AID12 subfield of the User Info field set to an AID of the non-AP MLD. BSRP Trigger frames and MU-RTS Trigger frames are examples of initial control frames.

In a general definition, it relates to a communication method in a wireless network, comprising, at a non-access point, non-AP, multi-link device, MLD in an active Enhanced Multi-Link Single Radio, EMLSR, mode:

responsive to receiving, over a first link of a set of enabled links in which links the EMLSR mode is applied, an initial control frame from the AP MLD not scheduling the non-AP MLD (but another non-AP MLD), switching a first affiliated STA corresponding to the first link in the non-AP MLD from a listening operation state to a disabled frame exchange state and switching a separate and second affiliated STA corresponding to a second link of the set in the non-AP MLD from a listening operation state to an enabled frame exchange state.

The initial control frame as defined in the D1.5 Standard is an initial Control frame of a frame exchange sequence with a non-AP MLD operating in the EMLSR mode.

The above means that upon detecting that the first link belongs to a channel on which the AP MLD initiates a frame exchange with another non-AP MLD, the non-AP MLD decides forcing its first link in a state where no frame exchange is possible (because the channel is busy) while its second link of the EMLSR links is set in the opposite state where a frame exchange is possible. In that way, the second affiliated STA is ready to now perform frame exchanges initiated by the AP MLD without a need to implement the initial control frame scheme over the second link (to switch its state). By saving the sending of the initial control frame, signaling is reduced and network bandwidth use improves. Furthermore, the second affiliated STA is involved quicker in this new frame exchange sequence with the AP MLD.

In some embodiments, the method further comprises, at the non-AP MLD being in the active EMLSR mode, sensing, over the first link of the set, an initial control frame response from another non-AP MLD,

wherein the switching operations are responsive to the sensing. This means the switching of the invention only occurs if a response to the initial control frame is provided by another non-AP MLD, addressee of the initial control frame, hence confirming the channel of the first link will be used by the AP MLD with one or more other non-AP MLDs.

In other embodiments, the method further comprises, at the non-AP MLD being in the active EMLSR mode, receiving a frame from the AP MLD over the second link, without having previously been scheduled by an initial control frame from the AP MLD over the second link since the second affiliated STA corresponding to the second link switched from the listening operation state to the enabled frame exchange state. Thanks to the invention, a frame exchange between the non-AP MLD not scheduled by the initial control frame and the AP MLD can directly take place over another EMLSR link than the first link.

In other embodiments, the method further comprises, at the non-AP MLD being in the active EMLSR mode, switching the first and second affiliated STAs back to the listening operation state upon detecting an end of frame exchanges over the second link. Exemplary conditions defining such end of frame exchanges are defined in the D1.5 Standard, section 35.3.17. This allows the non-AP MLD to return in a (conventional) state independently to the frame exchanges occurring over the channel of the first link. Consequently, the non-AP MLD is ready again to fully use the EMLSR mode with the AP MLD.

In other embodiments, in the active EMLSR mode, the first and second affiliated STAs listen simultaneously to the first and second links to receive an initial control frame from the AP MLD and only one the STA receiving an initial control frame is then configured to transmit or receive frames to or from the AP MLD after receiving the initial control frame until an end of a frame exchange.

From AP MLD's perspective, performing the frame exchange may include sending a downlink HE MU PPDU or sending a basic Trigger frame to trigger uplink communication.

In some embodiments, the frame is an initial control frame from the AP MLD that does not schedule the first non-AP MLD, and the method further comprises, at the AP MLD, receiving an initial control frame response from a non-AP MLD scheduled by the initial control frame, wherein directly performing the frame exchange is responsive to the receiving of the initial control frame response. Such response is therefore a condition to actually perform the initiated frame exchange sequence, hence to block the shared first link for the non-AP MLD not scheduled.

In other embodiments, the method further comprises, at the AP MLD, after sending the frame:

determining multiple (or all) non-AP MLDs being in the active EMLSR mode that share the same link as the first link in their set of enabled links and that are not explicitly triggered by the sent frame,

determining, for one or more of the determined non-AP MLDs, whether to perform a frame exchange (e.g. based on buffer status reports from the non-AP MLDs or on data locally stored in buffers) with the determined non-AP MLD, and in case of positive determining, triggering a direct performing of the frame exchange with the determined non-AP MLD over a link of its set of enabled links different from the shared link.

In some embodiments, the same mechanism of forcing a switch of an affiliated AP to an enabled frame exchange state may be implemented even when the non-AP MLD is scheduled by the initial control frame but the subsequent frames from the AP MLD does not explicitly trigger it. This is again to improve communication within the network, given the constraints of the EMLSR mode. This implementation may be combined with the first one above.

In such embodiments, the frame not explicitly triggering the non-AP MLD includes a frame not allocating any resource unit scheduled to the non-AP MLD or allocating any random access resource unit eligible by the non-AP MLD, over the first link. It means the frame does not have any User Info field addressed to the non-AP MLD. The method may thus include a step of detecting such frame not allocating resource unit to the non-AP MLD or to random access.

In some embodiments, the frame belongs to a frame exchange sequence initiated by an initial control frame previously sent by the AP MLD over the first link.

In some embodiments, responsive to the receiving, the first affiliated STA is switched from an enabled frame exchange state to the disabled frame exchange state and the second affiliated STA is switched from a disabled frame exchange state to the enabled frame exchange state. This means the non-AP MLD has previously received an initial control frame explicitly triggering it, over the first link.

In a general definition, the above relates to a communication method in a wireless network, comprising at a non-access point, non-AP, multi-link device, MLD in an active Enhanced Multi-Link Single Radio, EMLSR, mode:

responsive to receiving, over a first link of a set of enabled links in which links the EMLSR mode is applied, an initial control frame from the AP MLD scheduling the non-AP MLD, switching a first affiliated STA corresponding to the first link from a listening operation state to an enabled frame exchange state and switching a separate and second affiliated STA corresponding to a second link of the set from a listening operation state to a disabled frame exchange state. Here, the initial control frame explicitly triggers the non-AP MLD,

detecting, over the first link, a frame exchange initiated by the AP MLD through the initial control frame, wherein the frame exchange does not involve the non-AP MLD (e.g. no RU is scheduled or eligible to the non-AP MLD; more generally an initiated TXOP does not involve the non-AP MLD), and

responsive to the detecting, switching the first affiliated STA corresponding to the first link from the enabled frame exchange state to the disabled frame exchange state and switching the second affiliated STA corresponding to the second link from the disabled frame exchange state to the enabled frame exchange state.

In that way, the second affiliated STA becomes ready to exchange frames with the AP MLD although the second link was initially set in the disabled frame exchange state. This is because the first link is ultimately not involved in the frame exchanged initiated by the initial control frame and cannot be used due to the actual frame exchange over its channel. As a consequence, communication within the wireless network is improved.

In some embodiments, the method further comprises, at the non-AP MLD being in the active EMLSR mode, switching the first and second affiliated STAs to a listening operation state upon detecting an end of frame exchanges over the second link.

In alternative embodiments, the method further comprises, at the non-AP MLD being in the active EMLSR mode, switching the first affiliated STA back to the enabled frame exchange state and the second affiliated STA back to the disabled frame exchange state, upon detecting an end of frame exchanges over the second link.

First switch-back option allows the non-AP MLD to return in a (conventional) state independently to the frame exchanges occurring over the channel of the first link. Consequently, the non-AP MLD is ready again to fully use the EMLSR mode with the AP MLD.

Second switch-back option advantageously gives the non-AP MLD the opportunity to exchange frames with the AP MLD within the initiated frame exchange sequence over the first link. This is particularly applicable when the AP MLD intends to sequentially perform multiple transmissions during the initiated frame exchange sequence, e.g. by providing successive DL and UL sequences, or by using the cascading feature of the trigger-based MU UL transmissions.

In some embodiments, switching the first affiliated STA from the enabled frame exchange state to the disabled frame exchange state and switching the second affiliated STA from the disabled frame exchange state to the enabled frame exchange state include allocating to the second affiliated STA a full radio resource previously allocated to the first affiliated STA.

Correlatively, the invention also provides a wireless communication device comprising at least one microprocessor configured for carrying out the steps of any of the above methods. The wireless communication device may be either of a non-AP MLD and an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions between EMLSR-capable non-AP STAs in which the present invention may be implemented;

FIG. 2 schematically illustrates an exemplary sequence of frames of the EMLSR Operating Mode as specified in D1.5 standard;

FIG. 3 illustrates, using a flowchart, steps performed by an EMLSR-active non-AP MLD to handle initial Control frames sent by an EMLSR capable AP MLD, according to embodiments of the invention;

FIG. 4 illustrates, using a flowchart, corresponding steps performed by the EMLSR capable AP MLD, according to some embodiments of the invention;

FIG. 5 schematically illustrates these embodiments of FIGS. 3 and 4 using an exemplary sequence of frame exchange between the EMLSR capable AP MLD and EMLSR-active non-AP MLDs;

FIG. 6 illustrates, using a flowchart, steps performed by an EMLSR-active non-AP MLD operating in the EMLSR frame exchange mode when receiving a frame not allocating scheduled or eligible resources to it, according to embodiments of the invention;

FIG. 7 illustrates, using a flowchart, corresponding steps performed by the EMLSR capable AP MLD, according to some embodiments of the invention;

FIG. 8 schematically illustrates these embodiments of FIGS. 6 and 7 using an exemplary sequence of frame exchange between the EMLSR capable AP MLD and EMLSR-active non-AP MLDs;

FIG. 9 schematically illustrates an EMLSR capable architecture for an MLD to implement embodiments of the invention; and

FIG. 10 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or STAs. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., STAs). In some aspects, a wireless device or STA implemented in accordance with the teachings herein may comprise an access point (so-called AP) or not (so-called non-AP STA or STA).

While the examples are described in the context of WiFi (RTM) networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP STA may comprise, be implemented as, or known as a subscriber STA, a subscriber unit, a mobile STA (MS), a remote STA, a remote terminal, a user terminal (UT), a user agent, a user device, user equipment (UE), a user STA, or some other terminology. In some implementations, a STA may comprise a cellular telephone, a cordless telephone, a Session Initiation Protocol (“SIP”) phone, a wireless local loop (“WLL”) STA, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA may be a wireless node. Such wireless node may provide, for example, connectivity for or to a network (e.g., a wide area network such as the Internet or a cellular network) via a wired or wireless communication link.

An AP manages a set of STAs (registered to it or associated with it) that together organize their accesses to the wireless medium for communication purposes. The STAS (including the AP to which they register) form a service set, here below referred to as basic service set, BSS (although other terminology can be used). A same physical STA acting as an access point may manage two or more BSS (and thus corresponding WLANs): each BSS is thus uniquely identified by a specific basic service set identification, BSSID and managed by a separate virtual AP implemented in the physical AP. Each STA is identified within a BSS thanks to an identifier, AID, assigned to it by the AP upon registration.

The 802.11 family of standards define various media access control (MAC) mechanisms to drive access to the wireless medium.

The current discussions in the task group 802.11be, as illustrated by draft IEEE P802.11be/D1.5 of March 2022, introduce the Multi-Link Operation (MLO) when it comes to MAC layer operation. The MLO allows multi-link devices to establish or setup multiple links and operate them simultaneously.

A Multi-Link Device (MLD) is a logical entity and has more than one affiliated STA (STA) and has a single medium access control (MAC) service access point (SAP) to logical link control (LLC), which includes one MAC data service. An Access Point Multi-Link Device (or AP MLD) then corresponds to a MLD where each STA affiliated with the MLD is an AP, hence referred to as “affiliated AP”. A non-Access Point Multi-Link Device (or non-AP MLD) corresponds to a MLD where each STA affiliated with the MLD is a non-AP STA, referred to as “affiliated non-AP STA”. Depending on the literature, “multilink device”, “ML Device” (MLD), “multilink logical entity”, “ML logical entity” (MLE), “multilink set” and “ML set” are synonyms to designate the same type of ML Device.

Multiple affiliated non-AP STAs of a non-AP MLD can then setup communication links with multiple affiliated APs of an AP MLD, hence forming a multi-link channel.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHZ, 5 GHZ, 6 GHZ) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated STAs but not necessary a number equal to its number of affiliated STAs. In particular, a non-AP MLD may operate with a number of affiliated STAs greater than its number of radios (which can even be reduced to a single one).

An Enhanced Multi-Link Operating Mode (or EML OM in short), so-called EMLSR (Enhanced Multi-Link Single Radio) mode, has been defined by the D1.5 standard from this physical architecture.

Any non-AP MLD declares its support of the EMLSR mode (in its so-called EML Capabilities) to the AP MLD during the association phase. In operation mode, the activation and the deactivation of the EMLSR Mode is initiated by the non-AP MLD which sends a specific EHT action frame referred to as “EML OM Notification”, indicating in particular the set of enabled links (so-called EMLSR links) in which the EMLSR mode to activate is applied. Usually the set “EMLSR links” is made of two enabled links. However, a greater number of enabled links may be used. The EMLSR mode, once activated, allows the non-AP MLD to listen to the enabled links of the set “EMLSR links” simultaneously to receive initial control frames (e.g. MU-RTS trigger frames or BSRP trigger frames) transmitted by the AP MLD and next to perform data frames exchange with the AP MLD over only one link at a time, usually the link over which the initial control frame is received. Each non-AP MLD may support or not the EMLSR operating mode.

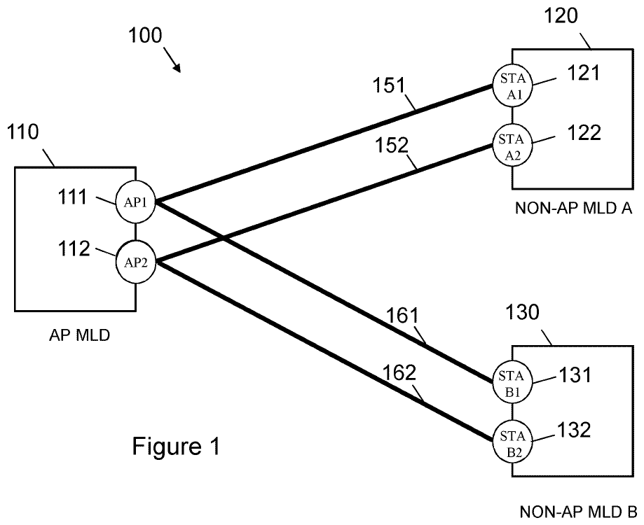

FIG. 1 illustrates a typical 802.11 network environment involving ML transmissions between EMLSR-capable non-AP MLDs in which the present invention may be implemented.

Wireless communication network 100 involves an AP MLD 110 and two non-AP MLDs 120 and 130. In the example, the two non-AP MLDs are considered to be EMLSR capable and have declared their EMLSR capabilities to the AP MLD 110. Of course, another number of non-AP MLDs registering to the AP MLD 110 and then exchanging frames with it may be contemplated, as well as another (greater) number of EMLSR-capable non-AP MLDs.

AP MLD 110 has multiple affiliated APs, two affiliated APs 111 and 112 (also referenced AP1, AP2 respectively) in the exemplary FIG. 1, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120, 130 have multiple affiliated non-AP STAs, each of which behaves as an 802.11 non-AP STA in a BSS (managed by an affiliated AP 111 or 112) to which it registers. In the exemplary FIG. 1, two non-AP STAs 121 and 122 (also referenced A1 and A2 respectively) are affiliated with non-AP MLD 120 and two non-AP STAs 131 and 132 (also referenced B1 and B2 respectively) are affiliated with non-AP MLD 130.

For illustrative purpose, non-AP MLDs 120 and 130 are single-radio non-AP MLDs. For example, AP 111 is set to operate on channel 38 corresponding to an operating 40 MHZ channel in the 5 GHz frequency band and AP 112 is set to operate on channel 151 corresponding to an operating 40 MHz channel in the 5 GHz frequency band too. In another example, the affiliated STAs could operate on different frequency bands.

Each affiliated AP offers a link towards the AP MLD 110 to the affiliated non-AP STAs of a non-AP MLD (120 or 130). Hence, the links for each non-AP MLD can be merely identified with the identifiers of the respective affiliated APs. In this context, each of the affiliated APs 111 and 112 can be identified by an identifier referred to as “link ID”. The link ID of each affiliated AP is unique and does not change during the lifetime of the AP MLD. AP MLD may assign the link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP STA of the non-AP MLD. Each of such links, referred to as “enabled link” enables individual channel access and frame exchanges between the non-AP MLD and the AP MLD based on supported capabilities exchanged during association.

The discovery phase is referred below to as ML discovery procedure, and the multi-link setup phase (or association phase) is referred below to as ML setup procedure.

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. Once a non-AP MLD has discovered the wireless communication network 100 through the ML discovery procedure and after an MLD authentication procedure, the ML setup procedure allows it to select a set of candidate setup links between its own affiliated non-AP STAs and some of the discovered affiliated APs and to request the AP MLD 110 to set up these links, which may be accepted or refused by the AP MLD. If the AP MLD accepts, the non-AP MLD is provided with an Association Identifier (AID) by the AP MLD, which AID is used by the affiliated non-APs of the non-AP MLD to wirelessly communicate over the multiple links (communication channels) with their corresponding affiliated APs. During the ML setup procedure, the non-AP MLDs declare part or all of their capabilities. For instance, they may declare their EMLSR capability. For this, appropriate fields are provided in the management frames. In particular, some of the management frames exchanged during the ML discovery and ML setup procedures contains a new Information Elements specific to the Multi-Link Operation (MLO), referred to as Basic Multi-Link element. De facto, in all Management frames that include a Basic Multi-Link element except Authentication frames, a non-AP or AP MLD which is EMLSR capable (dot11EHTEMLSROptionImplemented equal to true) sets, in the EML Capabilities subfield of the Common Info field, the EMLSR Support bit to 1.

For illustrative purpose, in wireless communication network 100, during the ML setup procedures, two candidate setup links have been requested by non-AP MLD 120 and accepted by AP MLD 110: a first link 151 between affiliated AP 111 (AP1) and affiliated non-AP STA 121 (A1), a second link 152 between affiliated AP 112 (AP2) and affiliated non-AP STA 122 (A2). Similarly, two candidate setup links have been requested by multi-radio non-AP MLD 130 and accepted by AP MLD 110: a first link 161 between affiliated AP 111 (AP1) and affiliated non-AP STA 131 (B1), a second link 162 between affiliated AP 112 (AP2) and affiliated non-AP STA 132 (B2).

AP MLD 110, non-AP MLD 120 and non-AP MLD 130 are EMLSR capable (dot11EHTEMLSROptionImplemented equal to true). They exchange their EMLSR capabilities during their ML discovery procedure and the multi-link setup phase.

When a non-AP MLD which is EMLSR capable intends to operate in the EMLSR mode on a set of enabled links, referred to as EMLSR links, a STA affiliated with the non-AP MLD transmits an EML Operating Mode (OM) Notification frame (specified in D1.5 standard) with the EMLSR Mode subfield of the EML Control field set to 1 to an AP affiliated with an AP MLD which is EMLSR capable (here AP MLD 110). The EMLSR links is indicated in the EMLSR Link Bitmap subfield of the EML Control field of the EML OM Notification frame by setting the bit positions of the EMLSR Link Bitmap subfield to 1. For example, in the EMLSR Bitmap, the bit position i corresponds to the link with the Link ID equal to i and is set to 1 to indicate that the link is a member of the EMLSR links.

The AP affiliated with the AP MLD that received the EML Operating Mode Notification frame from the STA affiliated with the non-AP MLD next transmits an EML Operating Mode Notification frame to one of the STAs affiliated with the non-AP MLD within the timeout interval indicated in the Transition Timeout subfield in the EML Capabilities subfield of the Basic Multi-Link element starting at the end of the PPDU transmitted by the AP affiliated with the AP MLD as an acknowledgement to the EML Operating Mode Notification frame transmitted by the STA affiliated with the non-AP MLD.

After the successful transmission of the EML Operating Mode Notification frame on one of the EMLSR links by the STA affiliated with the non-AP MLD, the non-AP MLD operates in the EMLSR mode.

When a non-AP MLD which is EMLSR capable intends to disable the EMLSR mode, a STA affiliated with the non-AP MLD transmits an EML Operating Mode (OM) Notification frame (specified in D1.5 standard) with the EMLSR Mode subfield of the EML Control field set to 0 to an AP affiliated with the AP MLD. Again, an AP affiliated with the AP MLD that received the EML Operating Mode Notification frame from the STA affiliated with the non-AP MLD transmits an EML Operating Mode Notification frame as above as an acknowledgement to the EML Operating Mode Notification frame. After the successful transmission of the EML Operating Mode Notification frame on one of the EMLSR links by the STA affiliated with the non-AP MLD, the non-AP MLD disables the EMLSR mode.

The set of STAs affiliated with an EMLSR capable non-AP MLD operating on the EMLSR links may be all or part of the STAs affiliated with the non-AP MLD. The STAs of this set are referred below to “EMLSR co-affiliated STAs” for the non-AP MLD.

In the example of FIG. 1, the EMLSR co-affiliated STAs of non-AP MLD 120 and of non-AP MLD 130 operate on the same links (i.e. with the same affiliated AP, AP1 and AP2) meaning they share the same EMLSR links. The present invention requires at least one shared EMLSR link between the two non-AP MLDs considered, meaning that alternative embodiments where enabled links 152 and 162 are implemented over separate channel with separate affiliated APs may also be contemplated.

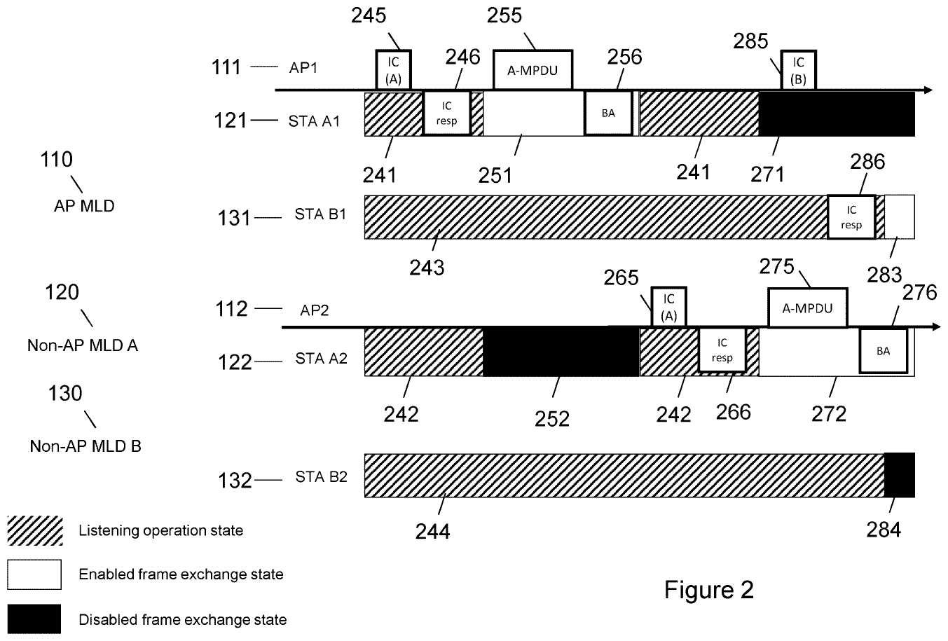

FIG. 2 illustrates, using a frames sequence, the EMLSR Operating Mode in non-AP MLDs 120, 130 when AP MLD 110 decides to use the EMLSR mode. In this sequence, the non-AP MLDs operate in the EMLSR mode, meaning EML Operating Mode Notification frames activating the EMLSR mode have been successfully transmitted by affiliated STAs of the two non-AP MLDs. In other words, they have entered an active Enhanced Multi-Link Single Radio, EMLSR, mode applying to a specific set of two or more enabled links.

The affiliated STAs AP1 121 and AP2 122 are EMLSR co-affiliated STAs within non-AP MLD 120, while the affiliated STAs B1 131 and B2 132 are EMLSR co-affiliated STAs within non-AP MLD 130.

Each of non-AP MLDs 120, 130 is able to listen simultaneously on its EMLSR links, by having its EMLSR co-affiliated STA(s) corresponding to those links in “awake” or “listening operation” state. For example, affiliated STAs A1, A2, B1, B2 are in the listening operation state (referenced 241, 242, 243, 244 respectively). The listening operation includes CCA (Clear Channel Assessment) and receiving an initial Control frame of frame exchanges that is initiated by the AP MLD. In each of non-AP MLDs 120, 130, the two EMLSR co-affiliated STAs therefore simultaneously listen for receiving the initial Control frame from the AP MLD. When the AP MLD 110 intends to initiate frame exchanges with one or more non-AP MLDs on one of the EMLSR links, it begins the frame exchanges by transmitting the initial Control frame 245 which explicitly triggers the non-AP MLD. The initial Control frame of frame exchanges is sent in the OFDM PPDU or non-HT duplicate PPDU format using a rate of 6 Mbps, 12 Mbps, or 24 Mbps. As defined in the D1.5 Standard, the initial Control frame may be an MU-RTS Trigger frame or a BSRP Trigger frame as defined in IEEE Std 802.11ax™-2021. Hence, an initial Control frame that explicitly triggers a non-AP MLD is synonymous to such a frame that schedule the non-AP MLD. Given the trigger frame format according to which such a frame includes one or more User Info fields, this condition means frame 245 includes a User Info field addressed to the non-AP MLD, i.e. where an AID12 field is set to the AID of the non-AP MLD (obtained upon registration).

In the present example and as shown by reference “IC(A)”, the initial Control frame 245 explicitly triggers non-AP MLD A 120. The initial Control frame may explicitly triggers multiple non-AP MLDs using multiple User Info fields therein.

The EMLSR co-affiliated STA of the non-AP MLD explicitly triggered by the initial Control frame 245 that receives the frame, e.g. affiliated STA A1 in the example, sends an Initial Control frame response (IC resp.) 246 to trigger or initiate a state change of the EMLSR co-affiliated STA of the non-AP MLD considered, e.g. a change of the states of affiliated STAs A1 and A2 in the example.

After receiving the initial Control frame of frame exchanges 245 and transmitting an immediate response frame 246 as a response to the initial Control frame, the STA affiliated with the non-AP MLD that was listening on the corresponding link, i.e. the receiving EMLSR co-affiliated STA A1 in the example, is configured to be able to transmit or receive frames on the enabled link in which the initial Control frame 245 was received, i.e. link 151 in the example. To do so, the receiving EMLSR co-affiliated STA is switched, after a link switch delay, from the listening operation state 241 to an “active frame exchange” or “enabled frame exchange” state, referenced 251 in the Figure. The receiving EMLSR co-affiliated STA is capable of receiving a PPDU that is sent using more than one spatial stream on the link in which the initial Control frame 245 was received a SIFS after the end of its response frame transmission 246 solicited by the initial Control frame.

Simultaneously, the other EMLSR co-affiliated STAs of the same non-AP MLD, i.e. STA A2 in the example, are configured not to transmit or receive on the other EMLSR link(s) until the end of the frame exchanges. To do so, the other EMLSR co-affiliated STAs are switched from the listening operation state 242 to a “blindness frame” or “disabled frame exchange” state, referenced 252 in the Figure. In particular, no data is transmitted by the AP MLD intended to these other EMLSR co-affiliated STAs.

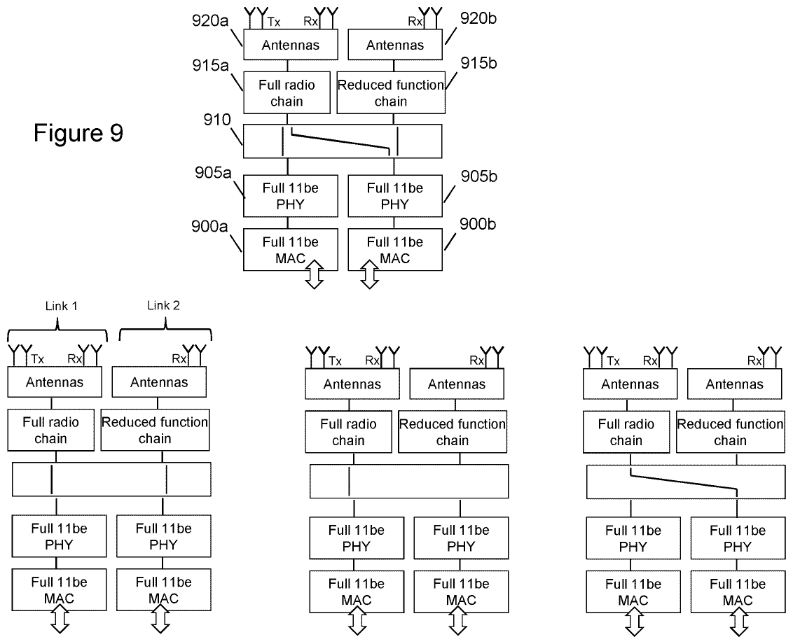

The state switches of all the EMLSR co-affiliated STAs within the same non-AP MLD are inseparable, because it is a question of allocating a full radio resource chain (see FIG. 9 below) to one of the STAs while the other are deprived of such chain.

The above shows that when a non-AP MLD operates in the EMLSR mode, it is either in a EMLSR listening operation mode (its EMLSR co-affiliated STAs are in the listening operation state) or in a EMLSR frame exchange mode (one of its EMLSR co-affiliated STA is in the enabled frame exchange state while the other EMLSR co-affiliated STAs are in the disabled frame exchange state).

The simultaneous state change is required because, in the EMLSR mode, a single full radio resource is available that is assigned to the receiving EMLSR co-affiliated STA only, as explained below with reference to FIG. 9.

It turns out that only one of the EMLSR co-affiliated STAs of an explicitly triggered non-AP MLD can perform data frames exchange at a time with the AP MLD; this is usually the EMLSR co-affiliated STAs which received the initial Control frame 245.

An exemplary frame exchange sequence is shown in the Figure that includes the sending of an A-MPDU frame 255 by the affiliated AP AP1 to the EMLSR co-affiliated STA A1 of explicitly triggered non-AP MLD A 120, followed by a corresponding block acknowledgment 256 from the latter.

During the frame exchange sequence initiated by the initial Control frame 245, non-AP MLD B 130 not addressed by the initial Control frame 245 remains in the EMLSR listening operation mode (its EMLSR co-affiliated STAs B1 and B2 remain in the listening operation state 243, 244).

After the end of the frame exchanges operated by the receiving EMLSR co-affiliated STA plus an EMLSR Transition Delay specified in the EML capabilities, the non-AP MLD 120 switches back to the EMLSR listening operation state, meaning that the receiving EMLSR co-affiliated STA A1 switches back to the listening operation state 241 as well as the other EMLSR co-affiliated STAs A2 (listening operation state 242). On the other hand, non-AP MLD 130 still remains in the EMLSR listening operation mode.

The EMLSR Transition Delay subfield in the EML capabilities indicates the transition delay time needed by a non-AP MLD to switch from exchanging frames on one of the enabled links to the listening operation on the enabled links. The EMLSR Transition Delay subfield is 3 bits and set to 0 for 0 μs, set to 1 for 16 μs, 2 for 32 μs, set to 3 for 64 μs, set to 4 for 128 μs, set to 5 for 256 μs, and the values 6 to 7 are reserved.

An end of frame exchanges can be sensed by a non-AP MLD, here non-AP MLD 120, if one of the following conditions is met:

(1) The MAC of the STA affiliated with the non-AP MLD that received the initial Control frame 245 does not receive a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement. This represents the end of an actual exchange with the AP MLD, without receiving a subsequent frame from the latter.

(2) The MAC of the STA affiliated with the non-AP MLD that received the initial Control frame 245 receives a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement, and the STA affiliated with the non-AP MLD does not detect, within the PPDU corresponding to the PHY-RXSTART.indication any of the following frames:
an individually addressed frame with the RA equal to the MAC address of the STA affiliated with the non-AP MLD,
a Trigger frame that has one of the User Info fields addressed to the STA affiliated with the non-AP MLD,
a CTS-to-self frame with the RA equal to the MAC address of the AP affiliated with the AP MLD,
a Multi-STA BlockAck frame that has one of the Per AID TID Info fields addressed to the STA affiliated with the non-AP MLD,
a NDP Announcement frame that has one of the STA Info fields addressed to the STA affiliated with the non-AP MLD.

This corresponds to the case where, after an actual exchange with the AP MLD, the non-AP MLD receives another frame from the AP MLD which is not addressed to it (i.e. no data is addressed to it or no resource is allocated to it).

(3) The STA affiliated with the non-AP MLD that received the initial Control frame 245 does not respond to the most recently received frame (e.g. A-MPDU frame 255) from the AP affiliated with the AP MLD that requires immediate response after a SIFS.

As both non-AP MLD 120 and 130 are now in the EMLSR listening operation mode, the AP MLD may initiate any new frame exchange sequence (with either of non-AP MLD 120 or 130) by transmitting a new initial Control frame.

In the example of the Figure, the AP MLD 110 decides to initiate such new sequence with non-AP MLD 120 again, through its EMLSR co-affiliated STA A2 122. In details, the AP MLD 110 through its other affiliated AP 112 transmits a new Initial Control frame 265 IC(A) explicitly triggering the non-AP MLD A 120, which frame is now received by the EMLSR co-affiliated STA A2 122. The receiving EMLSR co-affiliated STA A2 122 transmits a response frame 266 to the Initial Control frame 265. After a link switch delay, the explicitly triggered non-AP MLD 120 switches to EMLSR frame exchange mode where the receiving EMLSR co-affiliated STA A2 122 switches from the listening operation state 242 to the enabled frame exchange state 272 and its other EMLSR co-affiliated STA A1 121 switches from the listening operation state 241 to the disabled frame exchange state 271. As above, during this phase, the non-AP MLD 130 not explicitly triggered by the initial Control frame 265 remains in the EMLSR listening operation mode (its EMLSR co-affiliated STAs B1 and B2 remain in the listening operation state 243, 244).

Frames 275, 276 are then exchanged during the frame exchange sequence, up to the end of the sequence where the non-AP MLD 120 switches back to the EMLSR listening operation mode.

A-MPDU 255/275 is only provided as an illustration. Other types of frames can be sent by the AP MLD, e.g. basic Trigger frames to trigger UL transmissions. Although FIG. 2 shows frame exchanges made of a single frame 255/275 followed by an acknowledgment 256/276, simpler frame exchanges may only comprise a single frame sent by the AP MLD without acknowledgment, while more complex frame exchanges may comprise multiple sequences of exchanges, e.g. cascaded TXOPs for UL transmissions (triggered by a basic Trigger frame) and/or for DL transmissions (through an HE MU PPDU).

This illustrative example shows the advantages of the EMLSR mode in terms of throughput and latency: the AP MLD may switch quickly from one link to another link, hence improving communication performances for a limited increase of complexity and cost.

If the AP MLD 110 desires to engage frame exchanges with the not-explicitly-triggered non-AP MLD B 130, it only has link 161 with affiliated AP AP1 111 that is available (because the channel of link 162 with AP2 112 is busy due to the communication 275-276). In the current D1.5 standard, the AP MLD 110 must initiate a new sequence by transmitting, through its affiliated AP AP1 111, a new Initial Control frame 285 IC(B) explicitly triggering non-AP MLD B 130, which frame is received by the EMLSR co-affiliated STA B1 131. The receiving EMLSR co-affiliated STA B1 131 transmits a response frame 286 to the Initial Control frame 285. After a link switch delay, the non-AP MLD 130 switches to EMLSR frame exchange mode where the receiving EMLSR co-affiliated STA B1 131 switches from the listening operation state 243 to the enabled frame exchange state 283 and its other EMLSR co-affiliated STA B2 132 switches from the listening operation state 244 to the disabled frame exchange state 274. From then, frames (not shown) can be exchanged between affiliated AP AP1 111 and receiving EMLSR co-affiliated STA B1 131.

This situation is not satisfactory because of the signalling cost of Initial Control frame IC(B) 285 to allow an AP-initiated frame exchange to take place with non-AP MLD B 130.

The inventors have noticed that, since the link 162 with affiliated AP AP2 112 is busy for a period due to the frame exchange sequence with non-AP MLD A 120, the corresponding EMLSR co-affiliated STA B2 132 could be directly (when this sequence is initiated) set to the disabled frame exchange state and the other EMLSR co-affiliated STA B1 131 be set to the enabled frame exchange state, to immediately accept a frame exchange initiated by the AP MLD 110 without prior signalling of the initial Control frame 285.

Indeed, it is preferable to give the radio resource to the other EMLSR co-affiliated STA which operates on another channel/band during this period where link 162 is busy.

In that respect, embodiments provide that while the non-AP MLD B 130 is in the active EMLSR mode, it

receives, over a first enabled link 162 of the EMLSR links, an initial control frame

IC(A) 165 from the AP MLD 110 that does not explicitly trigger the non-AP MLD B 130 (but to the other non-AP MLD A 120), and

responsive to the receiving, switches the affiliated STA B2 132 corresponding to the first enabled link 162 in the not-explicitly-triggered non-AP MLD B 130 from the listening operation state 244 to the disabled frame exchange state 284 and switches the other affiliated STA B1 131 corresponding to a second enabled link 161 of the EMLSR links in the not-explicitly-triggered non-AP MLD B 130 from the listening operation state 243 to the enabled frame exchange state 283.

In these embodiments, the states of the EMLSR co-affiliated STAs of a not-explicitly-triggered non-AP MLD are switched contrary to known techniques. Furthermore, the affiliated STA state switch is now triggered by an initial Control frame not explicitly triggering that non-AP MLD, but another non-AP MLD sharing the same link over which this frame is sent.

Indeed, upon detecting that the shared link is now busy for a given period due to a frame exchange sequence with the other non-AP MLD initiated by the AP MLD on this link, the not-explicitly-triggered non-AP MLD can set this link as unusable, i.e. switches it in a state where no frame exchange is possible, but can make its second link of the EMLSR links as available for frame exchange, by switching it in an appropriate state. The initial control frame from the non-AP MLD is no longer required on this second link to initiate this frame exchange. By saving the sending of the initial control frame, signaling is reduced and network bandwidth use improves. Furthermore, the EMLSR co-affiliated STA corresponding to this second link is involved quicker in another data frame exchange sequence with the AP MLD.

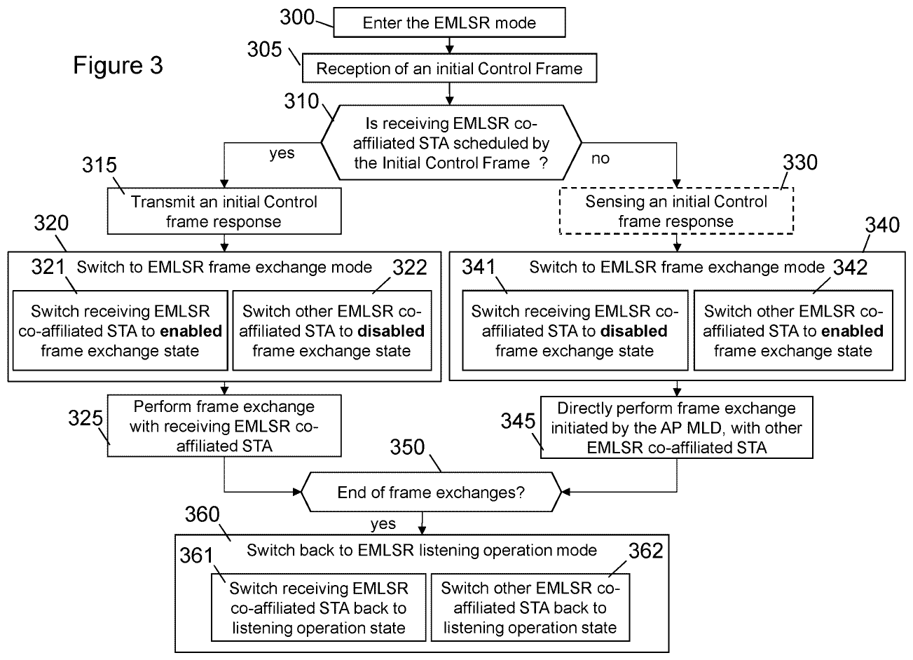

FIG. 3 illustrates, using a flowchart, exemplary steps for these embodiments, performed by a non-AP MLD.

A prerequisite is shown in step 300 where the non-AP MLD enters in the EMLSR mode, typically by successfully exchanging, with the EMLSR-capable AP MLD, an EML OM Notification with the EMLSR Mode subfield of the EML Control field set to 1, which notification specifies the EMLSR links, hence the corresponding EMLSR co-affiliated STAs.

The non-AP MLD is at that time in the EMLSR listening operation mode, meaning its EMLSR co-affiliated STAs are in the listening operation state, hence simultaneously listening to their respective link.

At step 305, an initial Control frame is received from the AP MLD by one of the EMLSR co-affiliated STAs on a receiving link.

The initial Control frame is typically a MU-RTS Trigger frame or a BSRP Trigger frame.

The MU-RTS Trigger frame relates to so-called MU-RTS/CTS procedure introduced in IEEE Std 802.11ax™-2021 and corresponds to an extension of the RTS/CTS handshake mechanism used to reserve the channel in multi-user UL/DL scenarios. It allows an AP to reserve a TXOP for multi-user transmission by sending a multi-user request control frame, noted MU-RTS frame, to request reservation of one or more 20 MHz communication channels. In response of the MU-RTS frame, the solicited/intended STA sends a CTS frame, which may thus be considered as an initial control frame response.

The BSRP Trigger frame relates to Buffer Status Report Poll (BSRP) procedure introduced in IEEE Std 802.11ax™-2021 in order to solicit the uplink data requirements of solicited STAs (in particular by requesting their buffered uplink data amounts) and allow the AP to schedule resource allocation for synchronized uplink transmissions. In response of the BSRP trigger frame, each solicited/intended STA can send an immediate feedback Buffer Status Report (BSR), which may thus be considered as an initial control frame response.

The format of both MU-RTS Trigger frame and BSRP Trigger frame corresponds to the Trigger frame format specified in section 9.3.1.22 of IEEE Std 802.11ax™-2021. For the MU-RTS Trigger frame, the Trigger Type field of the Common Info field of the Trigger frame is set to 3. For the BSRP Trigger frame, the Trigger Type field of the Common Info field of the Trigger frame is set to 4. A trigger frame contains several User Info fields, each one corresponding to an intended/solicited STA, referred to as recipient STA. The recipient STA is identified by the AID12 field of the User Info field which corresponds to the AID of the non-AP MLD in the ML context (i.e. assigned to the non-AP MLD by the AP MLD at the end of the ML setup procedure). The User Info field contains also a Resource Unit (RU) Allocation field which indicates the channel where the response shall be sent by the recipient STA, the response being a CTS in case of MU-RTS Trigger frame or a BSR in case of BSRP Trigger frame.

An initial Control frame as received at step 305 therefore schedules one or more recipient STAs, or more generally explicitly triggers one or more recipient STAs.

Step 310 checks whether the receiving EMLSR co-affiliated STA is scheduled or not-explicitly triggered by the received initial Control frame, or not. For this, it checks the presence of a User Info field in the received initial Control frame for which the AID12 field corresponds to the AID of the non-AP MLD.

In the affirmative, the non-AP MLD is a scheduled or explicitly-triggered non-AP MLD and the conventional process is performed through steps 315 to 325.

At step 315, the receiving EMLSR co-affiliated STA of the scheduled non-AP MLD transmits an initial Control frame response to the received initial Control frame, i.e. sends either a CTS or a BSR.

Next, at step 320, the scheduled non-AP MLD switches from the EMLSR listening operation mode to the EMLSR frame exchange mode, as already explained above with reference to FIG. 2.

For this, the receiving EMLSR co-affiliated STA corresponding to the receiving link is switched (321) from the listening operation state to the enabled frame exchange state, while in parallel (synchronously), the other EMLSR co-affiliated STA is switched (322) from the listening operation state to the disabled frame exchange state.

Next at step 325, the receiving EMLSR co-affiliated STA performs the frame exchange sequence with the corresponding affiliated AP over the receiving link.

In the negative of test 310, the non-AP MLD is a non-scheduled or not-explicitly-triggered non-AP MLD, and a switching process according to the invention is implemented, which includes the switching 340 of the non-AP MLD from the EMLSR listening operation mode to the EMLSR frame exchange mode, although it is not scheduled by the received initial Control frame (and thus does not send an initial Control frame response). Hence, the switching is responsive to the reception of the initial Control frame not scheduling or explicitly triggering the non-AP MLD.

In some embodiments, optional step 330 may be conducted before step 340, wherein an initial Control frame response from another non-AP MLD scheduled by the initial Control frame is sensed on the receiving link, before performing the switching 340. This makes that the switching is also responsive to the sensing of an initial Control frame response from another non-AP MLD.

The switching 340 includes the receiving EMLSR co-affiliated STA corresponding to the receiving link being switched (341) from the listening operation state to the disabled frame exchange state, while in parallel (synchronously), the other EMLSR co-affiliated STA corresponding to the other link of the EMLSR links being switched (342) from the listening operation state to the enabled frame exchange state.

Next at step 345, the other EMLSR co-affiliated STA can directly perform a frame exchange sequence initiated by the corresponding affiliated AP, without a need of receiving an initial Control frame for this sequence. This means the non-AP MLD being in the active EMLSR mode receives a frame from the AP MLD over the other link of the EMLSR links different from the receiving link, without having previously been explicitly triggered (or scheduled) by an initial control frame from the AP MLD over the other link since the EMLSR co-affiliated STA corresponding to the other link has switched from the listening operation state to the enabled frame exchange state.

The frame exchanges of steps 325 and 345 continue as long as no end of frame exchanges is detected (test 350) over the link used (the receiving link for frame exchange 325 and the other link for frame exchange 345). Exemplary conditions to detect an end of frame exchanges are provided above.

When such end of frame exchanges is detected at test 350, the non-AP MLD switches back to the EMLSR listening operation mode at step 360. For this, the receiving EMLSR co-affiliated STA corresponding to the receiving link is switched (361) back to the listening operation state, while in parallel (synchronously), the other EMLSR co-affiliated STA is also switched (362) back to the listening operation state.

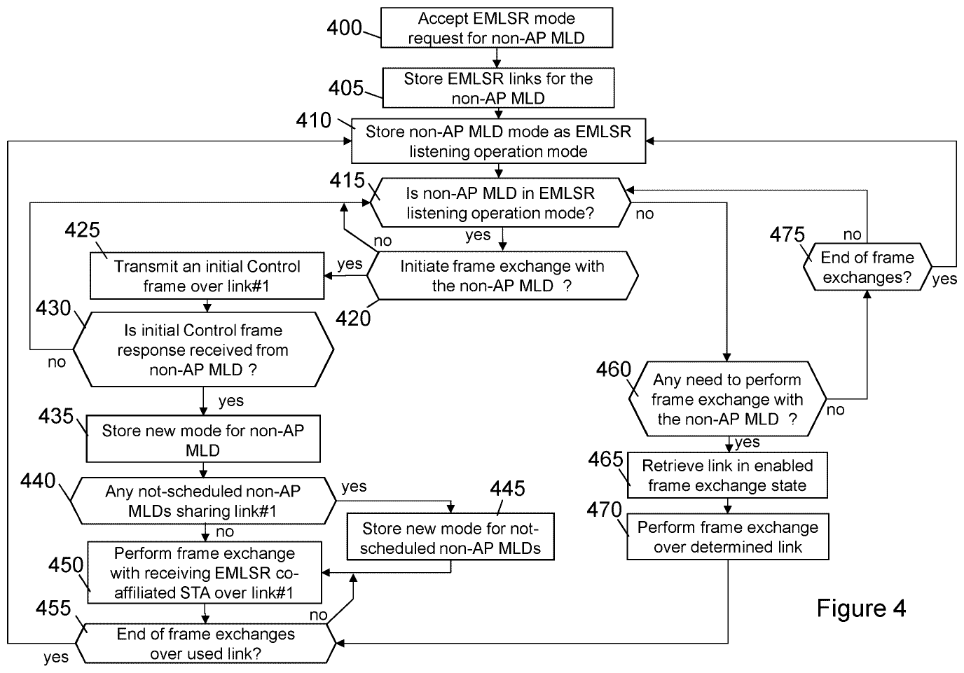

Turning now to the AP MLD side, FIG. 4 illustrates, using a flowchart, exemplary steps performed by the AP MLD with respect to a given non-AP MLD, meaning that the same process is performed with respect to each non-AP MLD entering the EMLSR mode.

Prerequisite step 400 corresponds to the successful exchange of EML OM Notifications with the non-AP MLD for the latter to enter the EMLSR mode. As mentioned above, the EML OM Notification received from the non-AP MLD specifies the EMLSR links, hence the corresponding EMLSR co-affiliated STAs.

Next, the AP MLD stores (step 405) the EMLSR links in local memory and stores (step 410) the non-AP MLD mode as being the EMLSR listening operation mode. For example, the AP MLD may store in local memory a first indication that a first link of the EMLSR links is in the listening operation state and a second indication that a second link of the EMLSR links is in the listening operation state too.

Next, the AP MLD checks (415) whether the non-AP MLD is in the EMLSR listening operation mode.

In the affirmative, it checks (420) whether there is a need to initiate a frame exchange sequence with one or more non-AP MLDs. Various criteria may be used for each non-AP MLD. For example, the AP MLD may have data in local buffer to send to the non-AP MLD. As another example, the AP MLD may be aware that the non-AP MLD needs uplink resources. As yet another example, the AP MLD may poll the non-AP MLD to know its buffer status reports.

If there is no need, the process loops back to step 415. Otherwise, the AP MLD transmits (425) an initial Control frame scheduling one or more non-AP MLDs over one shared link of their EMLSR links, referred to as Link #1 for simplicity. Test 430 checks whether a response to the initial Control frame is received in due time from the non-AP MLD or MLDs. In the negative, the process loops back to step 415. Otherwise, the non-AP MLD switches to the EMLSR frame exchange mode. Therefore, at step 435, the AP MLD stores in local memory such mode for each of the scheduled non-AP MLD. For example, the AP MLD may set the first indication for link #1 as being the enabled frame exchange state and a second indication for the other EMLSR link of each of the scheduled non-AP MLD as being the disabled frame exchange state.

With the present invention, step 435 is followed by step 440 during which the AP MLD searches for one or more other EMLSR-active and not-scheduled (or more generally not-explicitly-triggered) non-AP MLDs that share link #1 (i.e. have an EMLSR link with the same affiliated AP as link #1).

If no other EMLSR-active and not-scheduled non-AP MLD sharing link #1 is found, next step is step 450.

Otherwise, a new mode is stored for this or these other not-scheduled non-AP MLDs as determined at step 440. In particular, their new mode is the EMLSR frame exchange mode. Therefore, at step 445, the AP MLD stores in local memory such mode for each of the determined not-scheduled non-AP MLDs. For example, the AP MLD may set the first indication for link #1 of each determined not-scheduled non-AP MLD as being the disabled frame exchange state and a second indication for the other EMLSR link of each determined not-scheduled non-AP MLD as being the enabled frame exchange state. In such a way, each of the determined not-scheduled non-AP MLDs is ready to exchange frame over its EMLSR link other than Link #1.

Through steps 440 and 445, the AP MLD that has sent, over a first link of a set of enabled links in which links the EMLSR mode is applied by a first non-AP MLD, an initial control frame not explicitly triggering or not scheduling the first non-AP MLD to initiate a frame exchange sequence with another non-AP MLD, knows that it can now directly perform a frame exchange with the (not-scheduled) first non-AP MLD over a second link of the set of enabled links, without prior sending, over the second link, an initial control frame to schedule the first non-AP MLD, i.e. to switch an affiliated STA corresponding to the second link in the first non-AP MLD from a listening operation state to an enabled frame exchange state. This will be explained through steps 460-465 described below.

Furthermore, thanks to test 430 prior to steps 440 and 445, the direct performing of the frame exchange is responsive to the receiving by the AP MLD of a response to the initial control frame.

After step 445, step 450 is conducted where the AP MLD performs the initiated frame exchange sequence over Link #1 with the non-AP MLD.

Next step 455 detects whether the initiated frame exchange sequence ends, in which case the process loops back to step 410 to store back the non-AP MLD mode to the EMLSR listening operation mode. Exemplary conditions to detect a frame exchanges end are provided above with reference to FIG. 2.

Back to step 415, if it is determined that the non-AP MLD is not in the EMLSR listening operation mode (e.g. because step 445 is performed when initiating a sequence with another non-AP MLD sharing one EMLSR link with the non-AP MLD), next step is step 460 similar to step 420 to determine any need to perform a frame exchange with the non-AP MLD (which is already in EMLSR frame exchange mode although not-scheduled).

In the negative, the process goes to step 475 to determine whether any condition for the not-scheduled non-AP MLD to switch back to the EMLSR listening operation mode is met. Any condition (above) used to determine an end of frame exchanges can be used.

If a condition is met, the process loops back to step 410 to locally store the non-AP MLD's mode as being the EMLSR listening operation mode. Otherwise, the process loops back to step 415 for the AP MLD to continuously determine whether it has a need to initiate the frame exchange.

In the affirmative of test 460, the AP MLD retrieves (465) from its local memory the EMLSR link of the not-scheduled non-AP MLD that is in the enabled frame exchange state. Next, the AP MLD directly performs the frame exchanges with the not-scheduled non-AP MLD using the retrieved link, up to the end of the frame exchanges as detected through step 455. The direct frame exchange may include sending a downlink HE MU PPDU or sending a basic Trigger frame to trigger uplink communication.

This process allows for the AP MLD, after sending the initial control frame, to determine all non-AP MLDs in the active EMLSR mode that share the same link as Link #1 in their set of enabled links and that are not scheduled by the sent initial control frame, and then to determine, for one or more of the determined non-AP MLDs, whether to perform a frame exchange with the determined non-AP MLD, and in case of positive determining, to trigger a direct performing of the frame exchange with the determined non-AP MLD.

This process shows that the AP has now a new condition to drive the switch of an EMLSR co-affiliated STA of a non-AP MLD into the enabled frame exchange state, that is based on an initial Control frame not scheduling the non-AP MLD.

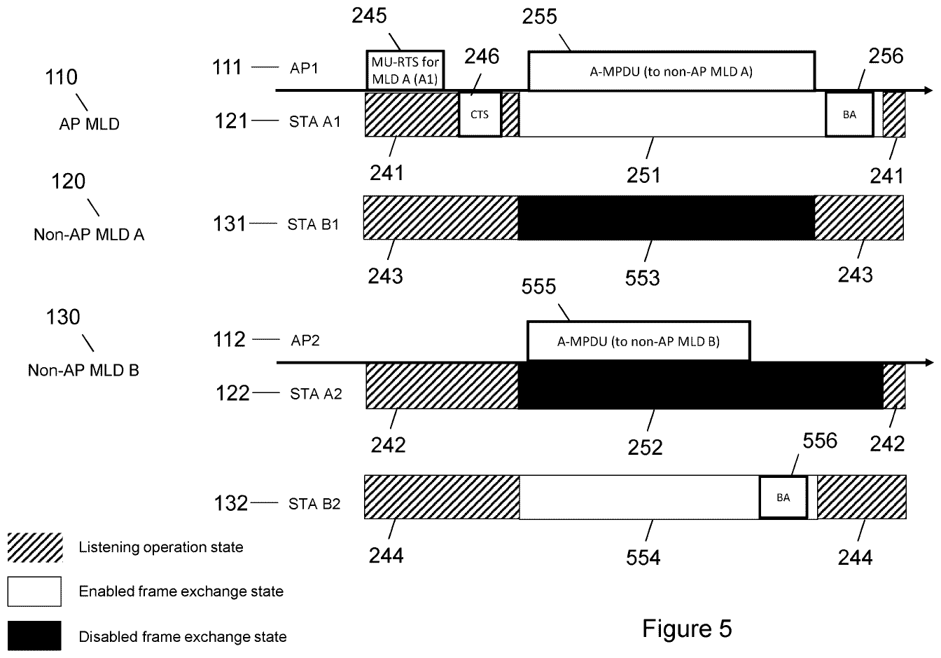

FIG. 5 schematically illustrates the above mechanism of the invention using an exemplary sequence of frame exchange between the EMLSR capable AP MLD and the EMLSR-active non-AP MLD at the reception of an initial Control frame not scheduling the non-AP MLD, according to embodiments of the invention.

For the purpose of illustration only, the initial Control frame is a MU-RTS trigger frame but the sequence of frames described would be the same with a BSRP trigger frame as initial Control frame.

The same references as FIG. 2 correspond to the same frame/state or the like.

Again, the AP MLD 110 includes two affiliated AP 111 and 112, the non-AP MLD 120 includes two affiliated STA 121 and 122 and the non-AP MLD 130 includes two affiliated STA 131 and 132.

Both non-AP MLDs 120 and 130 are EMLSR active with the EMLSR links corresponding to EMLSR co-affiliated STAs 121 and 122 for non-AP MLD 120 and the EMLSR links corresponding to EMLSR co-affiliated STAs 131 and 132 for non-AP MLD 130.

At the beginning of the sequence, both non-AP MLDs 120 and 130 are in the EMLSR listening operation mode, meaning that the EMLSR co-affiliated STAs 121 and 122 of non-AP MLD 120 are both in the listening operation state 241 and 242, as well the EMLSR co-affiliated STAs 131 and 132 of non-AP MLD 130 are both in the listening operation state 243 and 244.

When the AP MLD 110 desires to initiate a frame exchange sequence with non-AP MLD A 120, it transmits through its affiliated AP 111 a MU-RTS 245 as initial Control frame which is received by the EMLSR co-affiliated STA A1 121 of the non-AP MLD 120 and the EMLSR co-affiliated STA B1 131 of the non-AP MLD 130. The MU-RTS 245 schedules only non-AP MLD A 120.

In response to the MU-RTS 245, receiving EMLSR co-affiliated STA A1 121 of scheduled non-AP MLD A 120 transmits a CTS 246.

As described above with reference to FIG. 2, after a link switch delay, scheduled non-AP MLD 120 switches from the EMLSR listening operation mode to the EMLSR frame exchange mode (step 320), meaning its receiving EMLSR co-affiliated STA A1 121 switches from the listening operation state 241 to the enabled frame exchange state 251 (step 321) and its other EMLSR co-affiliated STA A2 122 switches from the listening operation state 242 to the disabled frame exchange state 252 (step 322). Frames 255 can then be exchanged between affiliated AP AP1 111 and the receiving EMLSR co-affiliated STA A1 121 being in the enabled frame exchange state 251.

Thanks to the invention, after the link switch delay, non-AP MLD 130 which is not scheduled by the initial Control frame 245 also switches from the EMLSR listening operation mode to the EMLSR frame exchange mode (step 340) because it shares the link with affiliated AP AP1 111 in its EMLSR link. With this switch, the receiving EMLSR co-affiliated STA B1 131 of not-scheduled non-AP MLD 130 switches from the listening operation state 243 to the disabled frame exchange state 553 (step 341) while its other EMLSR co-affiliated STA B2 132 switches from the listening operation state 242 to the enabled frame exchange state 554 (step 342).

Link 162 between affiliated AP AP2 112 and EMLSR co-affiliated STA B2 132 can now directly be used by the AP MLD to exchange frames, e.g. to send a downlink HE MU PPDU (A-MPDU 555) or a basic Trigger frame to trigger uplink communication.

It is to be noted that the two frame exchanges (255 and 555) continues independently to the other.

In particular, upon detecting (step 350) an end of the frame exchanges 555 (e.g. after block acknowledgment 556), not-scheduled non-AP MLD B 130 switches back to the EMLSR listening operation mode (step 360). The two EMLSR co-affiliated STA B1 131 and B2 132 of non-AP MLD B 130 switch back to the listening operation state 243, 244 (steps 361, 362).

At a different time, upon detecting (step 350) an end of the frame exchanges 255 (e.g. after block acknowledgment 256), scheduled non-AP MLD A 120 switches back to the EMLSR listening operation mode (step 360). The two EMLSR co-affiliated STA A1 121 and A2 122 of non-AP MLD A 120 switch back to the listening operation state 241, 242 (steps 361, 362).

The proposed mechanism described with reference to FIGS. 3 to 5 allows direct AP-initiated frame exchange with a non-AP MLD not scheduled by the initial Control frame 245, without requiring an initial Control frame scheduling that non-AP MLD to be transmitted to it.

There are however some situations where a scheduled non-AP MLD is blocked in the EMLSR frame exchange mode while it is not concerned by the AP-initiated frame exchange sequence, in particular not explicitly triggers by a subsequent frame starting the sequence. This is for example the case where the AP-initiated frame exchange sequence includes a trigger frame that does not allocate resources to the scheduled non-AP MLD but to other scheduled non-AP MLDs. In that case, it would be preferable to give the radio resource to the other EMLSR co-affiliated STA that the one (blocked) having received the initial Control frame, to operate on another channel/band during the blocking period.

To that end, embodiments of the invention concern the case where an initial control frame scheduling a non-AP MLD is received from the AP MLD over a first enabled link of the EMLSR links in which links the EMLSR mode is applied, and responsive to such receiving, the scheduled non-AP MLD switches to EMLSR frame exchange mode, i.e. a first EMLSR co-affiliated STA of the scheduled non-AP MLD corresponding to the first link is switched from the listening operation state to the enabled frame exchange state, and the other EMLSR co-affiliated STA corresponding to the other link of the EMLSR links is switched from the listening operation state to the disabled frame exchange state.

Embodiments of the invention then provides that the non-AP MLD detects, over the first link, a frame exchange initiated by the AP MLD through the initial control frame, wherein the frame exchange does not involve the scheduled non-AP MLD, and

responsive to the detecting, it switches the first EMLSR co-affiliated STA corresponding to the first link from the enabled frame exchange state to the disabled frame exchange state and switches the second EMLSR co-affiliated STA corresponding to the second link from the disabled frame exchange state to the enabled frame exchange state.

In other words, as soon as the scheduled non-AP MLD, engaged in an AP-MLD-initiated frame exchange sequence, detects that it is not involved in the actual frame exchange, it inverts the frame exchange states of its EMLSR co-affiliated STAs to recover radio resource over another link that the one over which the actual frame exchange is performed.

These embodiments of the invention therefore offer a better usage of the resources as the AP MLD may allocate resources to the other EMLSR co-affiliated STA contrary to the prior art.

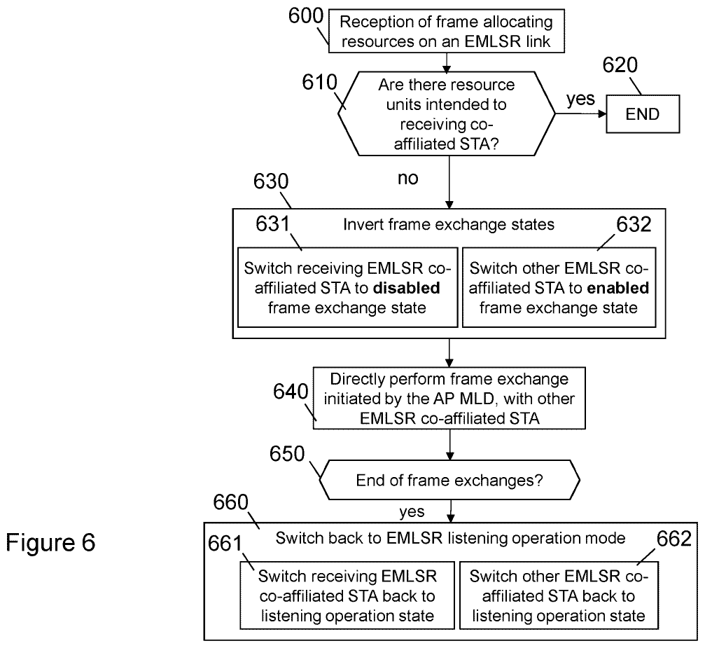

FIG. 6 illustrates, using a flowchart, exemplary steps for these embodiments, performed by a non-AP MLD.

The process starts after the scheduled non-AP MLD has entered the EMLSR mode, and has switched to the EMLSR frame exchange mode after having received an addressed initial Control frame scheduling it. The receiving EMLSR co-affiliated STA corresponding to the receiving link is in the enabled frame exchange state, while the other EMLSR co-affiliated STA corresponding to the other link of the EMLSR links is in the disabled frame exchange state. The full radio resource equipping the scheduled non-AP MLD is therefore allocated to the receiving EMLSR co-affiliated STA.

Step 600 consists in receiving a frame allocating resources on the receiving link for one or multiple non-AP MLDs scheduled by the initial Control frame. The resource allocation information is either at PHY or MAC level.

Next step 610 checks whether this frame involves the non-AP MLD. This may check for example whether the frame allocates or not any resource unit scheduled to the scheduled non-AP MLD or any random access resource unit eligible by the scheduled non-AP MLD.

In a Multi-User Uplink Orthogonal Frequency-Division Multiple Access (MU UL OFDMA), the frame allocating resources is typically a basic Trigger frame as specified in section 9.3.1.22 of IEEE Std 802.11ax™-2021 with a Trigger Type field of the Common Info field of the Trigger frame set to 0. The RU allocation information is contained at MAC level in the User Info fields included in the Trigger frame, each User Info field corresponding to an intended/solicited STA, referred to as recipient STA. Each User Info field contains notably an AID12 field identifying the recipient STA and a Resource Unit (RU) Allocation field indicating which channel to use by the recipient STA to send data.

In a Multi-User Downlink Orthogonal Frequency-Division Multiple Access (MU DL OFDMA), the frame transmitted by the AP contains both the allocation resources information and the DL data for multiple STAs. The RU allocation information is contained at PHY level in the HE-SIG-B field of the PHY header allowing STA to obtain it directly and consequently receive data on the specific RUs.

In both case, the scheduled non-AP MLD is therefore able to determine whether an UL or DL resource is assigned to it (through its AID), i.e. whether a User Info field is addressed to the scheduled non-AP MLD.

In the affirmative of test 610, conventional processing continues at step 620 where the frame exchange sequence is performed over the receiving link.

In the negative, the scheduled non-AP MLD inverts at step 630 the frame exchange states of its EMLSR co-affiliated STAs. In particular, the receiving EMLSR co-affiliated STA corresponding to the receiving link is switched (631) from its current enabled frame exchange state to the disabled frame exchange state (because the link is busy due to the frame allocating the resources) and in parallel (simultaneously) the other EMLSR co-affiliated STA corresponding to the other link of the EMLSR links is switched (632) from its current disabled frame exchange state to the enabled frame exchange state to recover radio resource on this other link.

In practice, this double switch consists in allocating the other EMLSR co-affiliated STA with the full radio resource previously allocated to the receiving EMLSR co-affiliated STA.

Once the state inversion has been made, the other EMLSR co-affiliated STA can directly perform a frame exchange sequence initiated by the corresponding affiliated AP, without a need of receiving an initial Control frame scheduling the non-AP MLD over the other link for this sequence. This is step 640.

The frame exchanges of step 640 continue as long as no end of frame exchanges is detected (test 650) over the other link used. Exemplary conditions to detect an end of frame exchanges are provided above.

When such end of frame exchanges is detected at test 650, the scheduled non-AP MLD switches back to the EMLSR listening operation mode at step 660. For this, the receiving EMLSR co-affiliated STA corresponding to the receiving link is switched (661) back to the listening operation state, while in parallel (synchronously), the other EMLSR co-affiliated STA is also switched (662) back to the listening operation state.

In a variant allowing the scheduled non-AP MLD to be involved in another part of the frame exchange sequence initiated by the initial Control frame, the scheduled non-AP MLD switches back to the mode it had before the inversion of step 630. This means, the scheduled non-AP MLD inverts again the frame exchange states of its EMLSR co-affiliated STAs. In particular, the receiving EMLSR co-affiliated STA corresponding to the receiving link is switched from its current disabled frame exchange state to the original enabled frame exchange state (to be able to participate to the initiated frame exchange sequence) and in parallel (simultaneously) the other EMLSR co-affiliated STA corresponding to the other link of the EMLSR links is switched from its current enabled frame exchange state to the original disabled frame exchange state. As the AP MLD also detects the end of frame exchanges, it is aware of when the scheduled non-AP MLD inverts back the frame exchange states of its EMLSR co-affiliated STAs. Therefore, it is able to appropriately exchange frames with the receiving EMLSR co-affiliated STA over the receiving link, during the initiated frame exchange sequence.

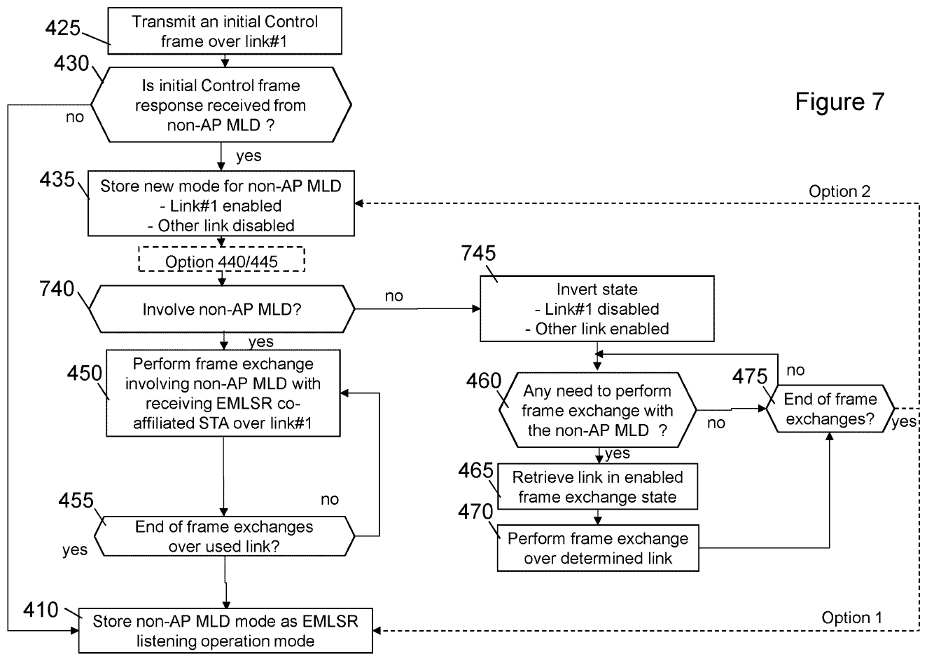

Turning now to the AP MLD side, FIG. 7 illustrates, using a flowchart, exemplary steps performed by the AP MLD with respect to a given non-AP MLD already in the EMLSR mode. The same process is performed with respect to each non-AP MLD in the EMLSR mode.

The same references as in FIG. 4 represent the same steps.

The process starts at step 425 where the AP MLD transmits an initial Control frame scheduling the non-AP MLD over one of the EMLSR links, referred to as Link #1 for simplicity. Exemplary reasons for transmitting such frame are provided above.

Test 430 checks whether a response to the initial Control frame is received in due time from the scheduled non-AP MLD. In the negative, the process ends at step 410 where the non-AP MLD in question is saved as being in the EMLSR listening operation mode.

Otherwise, the scheduled non-AP MLD switches to the EMLSR frame exchange mode. Therefore, at step 435, the AP MLD stores in local memory such mode for the scheduled non-AP MLD. For example, the AP MLD may set the first indication for link #1 as being the enabled frame exchange state and a second indication for the other EMLSR link as being the disabled frame exchange state.

Steps 440 and 445 described above may optionally be implemented, meaning this mechanism may be combined with the one presented above with reference to FIGS. 3 to 5.

Next, the initiates frame exchange sequence may start.

At step 740, the AP MLD determines whether it involves the scheduled non-AP MLD in the next frame to send. The criteria for such determination may be those described above for step 610.

In the affirmative, conventional processing is conducted where, at step 450, the AP MLD sends its frame involving the non-AP MLD over Link #1. Next step 455 detects whether the initiated frame exchange sequence ends, in which case the process goes to step 410 to store back the non-AP MLD mode to the EMLSR listening operation mode. Exemplary conditions to detect a frame exchanges end are provided above with reference to FIG. 2.

With the present invention, in the negative of test 740, the AP MLD stores in memory an inversion of the frame exchange states of the EMLSR co-affiliated STAs of the non-AP MLD (step 745). For example, the AP MLD may set the first indication for link #1 as being the disabled frame exchange state and the second indication for the other EMLSR link as being the enabled frame exchange state.

Based on this information, the AP MLD determines at step 460 any need to perform a frame exchange with the non-AP MLD.

In the negative, the process goes to step 475 to determine whether any condition for the non-AP MLD to switch back its EMLSR co-affiliated STAs to other states is met. Any condition (above) used to determine an end of frame exchanges can be used.

If a condition is met, the process goes to step 410 (option 1) to locally store the non-AP MLD mode as being the EMLSR listening operation mode, or goes to step 435 (option 2) to recover the previous states for its EMLSR co-affiliated STAs, namely the AP MLD may set the first indication for link #1 back to the enabled frame exchange state and the second indication for the other EMLSR link back to the disabled frame exchange state.

If no condition is met, the process loops back to step 460 for the AP MLD to continuously determine whether it has a need to perform a frame exchange with the non-AP MLD.

In the affirmative of test 460, the AP MLD retrieves (465) from its local memory the EMLSR link of the non-AP MLD that is in the enabled frame exchange state. Next, the AP MLD directly performs the frame exchanges with the non-AP MLD using the retrieved link, up to the end of the frame exchanges as detected through step 475. The direct frame exchange may include sending a downlink HE MU PPDU or sending a basic Trigger frame to trigger uplink communication.

This process shows that the AP has now a new condition to drive the switch of the EMLSR co-affiliated STAs of the non-AP MLD from one (enabled/disabled) frame exchange mode to the other, hence recovering an additional opportunity to exchange frames with that non-AP MLD.

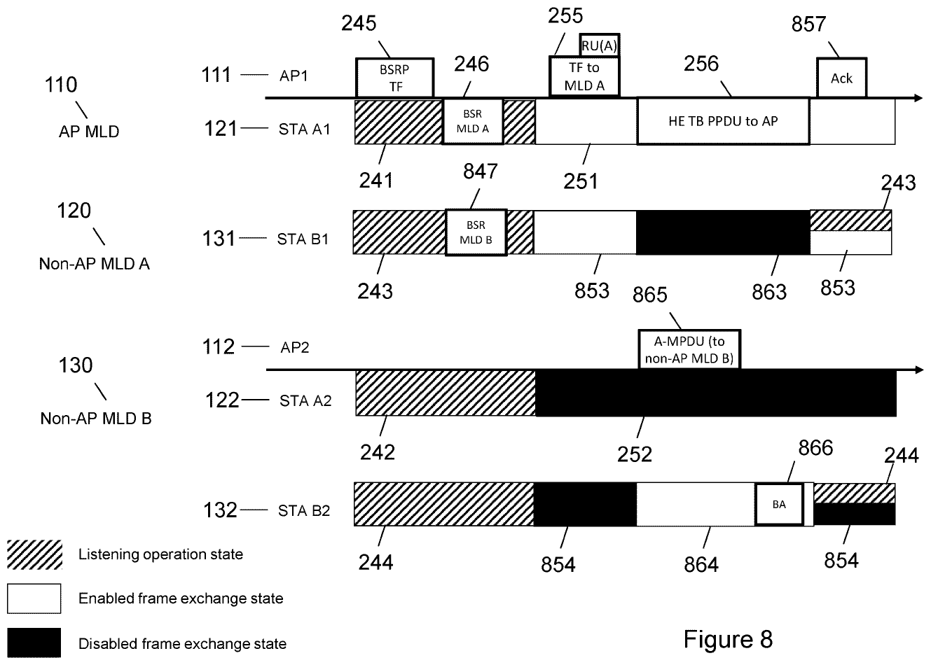

FIG. 8 schematically illustrates the above mechanism of the invention using an exemplary sequence of frames of a non-AP MLD which operates in the EMLSR frame exchange mode at the reception of a frame allocating resources not involving said non-AP MLD, according to embodiments of the invention.

For the purpose of illustration, the initial Control frame is a BSRP Trigger frame in a context of a MU UL OFDMA transmission. Of course, a MU-RTS Trigger frame could be used as an alternative.

The same references as FIG. 2 correspond to the same frame/state or the like.

Again, the AP MLD 110 includes the two affiliated AP 111 and 112, the non-AP MLD 120 includes the two affiliated STA 121 and 122 and the non-AP MLD 130 includes two affiliated STA 131 and 132

Both non-AP MLDs 120 and 130 are EMLSR active with the EMLSR links corresponding to EMLSR co-affiliated STAs 121 and 122 for non-AP MLD 120 and the EMLSR links corresponding to EMLSR co-affiliated STAs 131 and 132 for non-AP MLD 130.

At the beginning of the sequence, both non-AP MLDs 120 and 130 are in the EMLSR listening operation mode, meaning that the EMLSR co-affiliated STAs 121 and 122 of non-AP MLD 120 are both in the listening operation state 241 and 242, as well the EMLSR co-affiliated STAS 131 and 132 of non-AP MLD 130 are both in the listening operation state 243 and 244.

When the AP MLD 110 desires to initiate a frame exchange sequence with non-AP MLDs A 120 and B 130 to know their BSRs, it transmits through its affiliated AP 111 a BSRP Trigger frame 245 as initial Control frame which is received by the EMLSR co-affiliated STA A1 121 of the non-AP MLD 120 and the EMLSR co-affiliated STA B1 131 of the non-AP MLD 130.

The BSRP Trigger frame 245 schedules both non-AP MLD A 120 and non-AP MLD B 130.

In response to the BSRP 245, receiving EMLSR co-affiliated STA A1 121 of scheduled non-AP MLD A 120 transmits a BSR 246 indicating the amount of buffered uplink data of the scheduled non-AP MLD A 120 and receiving EMLSR co-affiliated STA B1 131 of scheduled non-AP MLD B 130 transmits a BSR 847 indicating the amount of buffered uplink data of the scheduled non-AP MLD B 130.

As described above with reference to FIG. 2, after a link switch delay, both scheduled non-AP MLD 120 and non-AP MLD 130 switches from the EMLSR listening operation mode to EMLSR frame exchange mode (step 320), meaning the receiving EMLSR co-affiliated STAs A1 121 and B1 131 switch both from the listening operation state 241, 243 to the enabled frame exchange state 251, 853, while the other EMLSR co-affiliated STAs A2 122 and B2 132 switch respectively from the listening operation state 242, 244 to the disabled frame exchange state 252, 854.

Frames 255 can then be exchanged within the initiated frame exchange sequence, i.e. over link #1 with affiliated AP AP1 111. Various types of frames 255 can be used, e.g. a downlink HE MU PPDU or a basic Trigger frame to trigger uplink communication.

The AP MLD 110 through the affiliated AP 111 transmits e.g. a Basic Trigger frame 255 containing a RU allocation information indicating that a resource unit is assigned for scheduled non-AP MLD A 120 but not for scheduled non-AP MLD B 130:
the non-AP MLD A 120 is therefore scheduled (more generally explicitly triggered) by frame 255 and can then perform the frame exchange by providing a response, here a HE TB PPDU 256,
while the non-AP MLD B 130 is not scheduled (more generally not explicitly triggered) by frame 255.

Thanks to the invention, after a link switch delay after frame 255, the non-AP MLD B 130 which is not involved by frame 255 inverts the frame exchange states of its EMLSR co-affiliated STAs (step 630). In particular, the receiving EMLSR co-affiliated STA A1 131 switches from its current enabled frame exchange state 853 to the disabled frame exchange state 863 (step 631) while in parallel (synchronously), the other EMLSR co-affiliated STA B2 132 switches from its current disabled frame exchange state 854 to the enabled frame exchange state 864 (step 632).

Link 162 between affiliated AP AP2 112 and EMLSR co-affiliated STA B2 132 can now directly be used by the AP MLD to exchange frames, e.g. for the affiliated AP AP2 112 to send a downlink HE MU PPDU (A-MPDU 865 in the example of the Figure) or a basic Trigger frame to trigger uplink communication to non-AP MLD B 130.

It is to be noted that the two frame exchanges (255-256 and 865) continues independently to each other.

In particular, upon detecting (step 650) an end of the frame exchanges 865 (e.g. after block acknowledgment 866), non-AP MLD B 130 switches back:
(option 1) to the EMLSR listening operation mode (step 360): the two EMLSR co-affiliated STA B1 131 and B2 132 of non-AP MLD B 130 switch back to the listening operation state 243, 244 (steps 661, 662),
(option 2) or alternatively to the previous EMLSR frame exchange mode before the inversion of step 630: the receiving EMLSR co-affiliated STA B1 131 is switched from its current disabled frame exchange state back to the original enabled frame exchange state and in parallel (simultaneously) the other EMLSR co-affiliated STA B2 132 corresponding to the other link of the EMLSR links is switched from its current enabled frame exchange state back to the original disabled frame exchange state.

At a different time, upon detecting an end of the frame exchanges 255-256 (e.g. after acknowledgment 857), non-AP MLD A 120 switches back (not shown) to the EMLSR listening operation mode.

FIG. 9 schematically illustrates an EMLSR capable architecture for an MLD. This Figure takes the example of two affiliated non-AP STAs sharing their antenna resources when the EMLSR mode is activated.

The architecture comprises two radio stacks, one for each EMLSR co-affiliated non-AP STA.

A radio stack comprises a full 802.11be MAC module 900a or 900b (exchanging data with higher layers), a full 802.11be PHY module 905a or 905b connected with the MAC module, a radio-frequency chain 915a or 915b connected with the PHY module through an EMLSR switch 910, each radio-frequency chain ending with antennas 920a, 920b. The EMLSR switch 910 is shared by the two radio stacks and configured to switch to one or the other of the radio chains 915a/920a and 915b/920b when the EMLSR mode is activated. The radio chain 915a/920a is a full radio resource allowing transmission and reception of frames. In particular, it includes encoding and decoding modules to encode and decode frames. On the other hand, the radio chain 915b/920b is a reduced function radio which only allows reception of frames. In particular, it only includes a decoding module to decode frames.

The diagram on the bottom left illustrates the functioning of the MLD when the non-AP MLD is in the EMLMR listening operation mode: the common EMLSR switch 915 connects each radio chain 915/920 to its PHY and MAC modules. Hence, each radio stack can be used to simultaneously listen to a respective link. As shown in the Figure, two links are available.

The diagram on the bottom center illustrates the functioning of the MLD when the non-AP MLD is in the EMLMR frame exchange mode in which link 1 is the link over which the initial Control frame has been received. The EMLSR co-affiliated STA corresponding to link 1 is in the enabled frame exchange state, while the other EMLSR co-affiliated STA is in the disabled frame exchange state. In that case, the full radio resource chain 915a/920a is connected to the receiving ELMSR co-affiliated STA (PHY 905a, MAC 900a) to receive and transmit frames, while the other ELMSR co-affiliated STA (PHY 905b, MAC 900b) is not connected to a radio chain. Only one link is available.

The diagram on the bottom right illustrates the functioning of the MLD when the non-AP MLD is in the EMLMR frame exchange mode in which link 2 is the link over which the initial Control frame has been received. The EMLSR co-affiliated STA corresponding to link 2 is in the enabled frame exchange state, while the other EMLSR co-affiliated STA is in the disabled frame exchange state. In that case, the common EMLSR switch 910 connects the full radio chain 915a/920a to the second radio stack 905b/900b so that the receiving ELMSR co-affiliated STA benefits from a full radio resource stack to receive and transmit frames. On the other hand, the other ELMSR co-affiliated STA has no longer a full radio stack, hence is no longer capable to receive and transmit frames. Again only one link is available.

The functioning of the common EMLSR switch 910 clearly shows that the change of states for two EMLSR co-affiliated STAs in the same MLD is necessarily simultaneous because the radio chain is either connected to one of the STAs or to the other, but never remains available for both STAs at the same time.

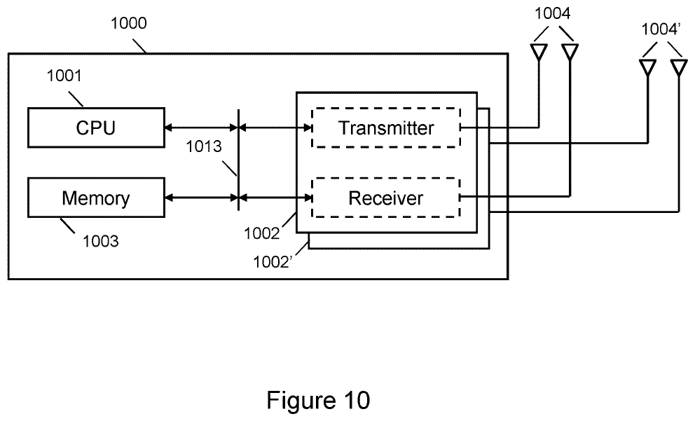

FIG. 10 schematically illustrates a communication device 1000, typically any of the MLDs discussed above, of a wireless network, configured to implement at least one embodiment of the present invention. The communication device 1000 may preferably be a device such as a micro-computer, a workstation or a light portable device. The communication device 1000 comprises a communication bus 1013 to which there are preferably connected:

a central processing unit 1001, such as a processor, denoted CPU;

a memory 1003 for storing an executable code of methods or steps of the methods according to embodiments of the invention as well as the registers adapted to record variables and parameters necessary for implementing the methods; and

at least two communication interfaces 1002 and 1002′ connected to the wireless communication network, for example a communication network according to one of the IEEE 802.11 family of standards, via transmitting and receiving antennas 1004 and 1004′, respectively.

Preferably the communication bus 1013 provides communication and interoperability between the various elements included in the communication device 1000 or connected to it. The representation of the bus is not limiting and in particular the central processing unit is operable to communicate instructions to any element of the communication device 1000 directly or by means of another element of the communication device 1000.

The executable code may be stored in a memory that may either be read only, a hard disk or on a removable digital medium such as for example a disk. According to an optional variant, the executable code of the programs can be received by means of the communication network, via the interface 1002 or 1002′, in order to be stored in the memory of the communication device 1000 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, including, at a non-access point (non-AP), multi-link device (MLD) in an active Enhanced Multi-Link Single Radio (EMLSR) mode, comprising:
responsive to receiving, over a first link of a set of enabled links in which links the EMLSR mode is applied, a frame from the AP MLD not explicitly triggering the non-AP MLD;
switching a first affiliated STA corresponding to the first link in the non-AP MLD to a disabled frame exchange state; and
switching a separate and second affiliated STA corresponding to a second link of the set in the non-AP MLD to an enabled frame exchange state.

2. The method of claim 1, wherein the frame is an initial control frame from the AP MLD that does not schedule the non-AP MLD, and responsive to the receiving, the first affiliated STA is switched from a listening operation state to the disabled frame exchange state and the separate and second affiliated STA is switched from a listening operation state to the enabled frame exchange state.

3. The method of claim 2, further comprising, at the non-AP MLD being in the active EMLSR mode, sensing, over the first link of the set, an initial control frame response from another non-AP MLD,
wherein the switching operations are responsive to the sensing.

4. The method of claim 2, further comprising, at the non-AP MLD being in the active EMLSR mode, receiving a frame from the AP MLD over the second link, without having previously been scheduled by an initial control frame from the AP MLD over the second link since the second affiliated STA corresponding to the second link switched from the listening operation state to the enabled frame exchange state.

5. The method of claim 2, further comprising, at the non-AP MLD being in the active EMLSR mode, switching the first and second affiliated STAs back to the listening operation state upon detecting an end of frame exchanges over the second link.

6. The method of claim 1, wherein in the active EMLSR mode, the first and second affiliated STAs listen simultaneously to the first and second links to receive an initial control frame from the AP MLD and only one the STA receiving an initial control frame is then configured to transmit or receive frames to or from the AP MLD after receiving the initial control frame until an end of a frame exchange.

7. The method of claim 1, wherein the frame not explicitly triggering the non-AP MLD includes a frame not allocating any resource unit scheduled to the non-AP MLD or allocating any random access resource unit eligible by the non-AP MLD, over the first link.

8. The method of claim 1, wherein the frame belongs to a frame exchange sequence initiated by an initial control frame previously sent by the AP MLD over the first link.

9. The method of claim 1, wherein responsive to the receiving, the first affiliated STA is switched from an enabled frame exchange state to the disabled frame exchange state and the second affiliated STA is switched from a disabled frame exchange state to the enabled frame exchange state.

10. The method of claim 9, further comprising, at the non-AP MLD being in the active EMLSR mode, switching the first and second affiliated STAs to a listening operation state upon detecting an end of frame exchanges over the second link.

11. The method of claim 9, further comprising, at the non-AP MLD being in the active EMLSR mode, switching the first affiliated STA back to the enabled frame exchange state and the second affiliated STA back to the disabled frame exchange state, upon detecting an end of frame exchanges over the second link.

12. The method of claim 9, wherein switching the first affiliated STA from the enabled frame exchange state to the disabled frame exchange state and switching the second affiliated STA from the disabled frame exchange state to the enabled frame exchange state include allocating to the second affiliated STA a full radio resource previously allocated to the first affiliated STA.

13. The method of claim 1, wherein a frame not explicitly triggering the non-AP MLD includes a frame having no User Info field addressed to the non-AP MLD.

14. The method of claim 13, wherein a frame not including a User Info field addressed to the non-AP MLD includes a frame in which none of the conditions are met:
an AID12 subfield of the User Info field includes an AID of the non-AP MLD,
an AID12 subfield of the User Info field indicates allocation of one or more random access resource units for non-AP MLDs already associated with the AP MLD.

15. A communication method in a wireless network, including, at an access point (AP), multi-link device (MLD) managing non-AP MLDs operating in an active Enhanced Multi-Link Single Radio (EMLSR) mode, comprising:
sending, over a first link of a set of enabled links in which links the EMLSR mode is applied by a first non-AP MLD, a frame, not explicitly triggering the first non-AP MLD, to perform a frame exchange sequence with another non-AP MLD; and
directly performing a frame exchange with the first non-AP MLD over a second link of the set of enabled links, without prior sending, over the second link, an initial control frame scheduling the first non-AP MLD.

16. The method of claim 15, wherein performing the frame exchange includes sending a downlink HE MU PPDU or sending a basic Trigger frame to trigger uplink communication.

17. The method of claim 15, wherein the frame is an initial control frame from the AP MLD that does not schedule the first non-AP MLD, and the method further comprises, at the AP MLD, receiving an initial control frame response from a non-AP MLD scheduled by the initial control frame, wherein directly performing the frame exchange is responsive to the receiving of the initial control frame response.

18. The method of claim 15, further comprising, at the AP MLD, after sending the frame:
determining multiple non-AP MLDs being in the active EMLSR mode that share the same link as the first link in their set of enabled links and that are not explicitly triggered by the sent frame,
determining, for one or more of the determined non-AP MLDs, whether to perform a frame exchange with the determined non-AP MLD, and in case of positive determining, triggering a direct performing of the frame exchange with the determined non-AP MLD over a link of its set of enabled links different from the shared link.

19. The method of claim 15, wherein the frame belongs to a frame exchange sequence initiated by an initial control frame previously sent by the AP MLD over the first link.

20. A wireless communication device comprising at least one microprocessor configured for carrying out the steps of the method of claim 1.

21. A non-transitory computer-readable medium storing a program which, when executed by a microprocessor or computer system in a wireless device, causes the wireless device to perform the method of claim 1.

22. A wireless communication device comprising at least one microprocessor configured for carrying out the steps of the method of claim 15.
